(19) United States
(12) Patent Application Publication
(10) Pub. No.: US 2009/0128785 A1
(43) Pub. Date: May 21, 2009

(54) MULTIFUNCTION PROJECTOR CASE WITH SCREEN

(76) Inventor: Barry D. Silverstein, Rochester, NY (US)

Correspondence Address: David A. Novais;Patent Legal Staff, Eastman Kodak Company, 343 State Street, Rochester, NY, 14650-2201, US

(21) Appl. No.: 11/940,543

(22) Filed: Nov. 15, 2007

(51) Int. Cl. G03B 21/14

(52) U.S. Cl. 353/119

(57) ABSTRACT

A case for holding a portable projection device, the case including a housing having interior surfaces for holding the portable projection device; and a projection screen for viewing images from the portable projection device.

### FIELD OF THE INVENTION

This invention generally relates to an apparatus for housing and providing an imaging surface for a display device and more particularly relates to an improved apparatus containing a projection device and also providing the projection device a surface on which to image.

### BACKGROUND OF THE INVENTION

Portable projectors have been developing at a rapid pace since the 1990's. As portable computing increases in its capabilities, so does the need for portable display. Many devices incorporate their own displays such as thin film transistor (TFT) based liquid crystal displays (LCD) or organic light emitting diodes (OLED) used in laptop computers, MP3 players, digital cameras and cell phones. These types of displays have many limitations. In the case of cell phones and MP3 players, the displays are often considered too small to view images and are essentially only intended solely for a single viewer. In situations where multiple viewers or extended viewing of detailed content is desired, small displays on the order of 3 inches in diagonal are impractical for most viewers and not usable for the worlds increasing aging population with degrading eyesight. Larger displays like those used in laptops from 10″-17″ diagonals are easier to view by more than one person; however, they have limited portability and are typically tied directly to the computing device. Additionally, these larger displays often utilize higher amounts of energy, which adds more weight to the package in terms of batteries, or shortens the practical operational lifetime, further cutting the portability and usability.

Alternately, desktop projectors, such as those typically used as office or school projectors, are fabricated utilizing either transmissive LCD or reflective digital micro-mirror (DMD) type microdisplays, offer flexibility of connection to multiple devices and are bright enough, above 50 nits to allow projection significantly larger than a 3 inch diagonal. While these projectors are designed for multiple users, they are fairly large and consume significant power. These projectors have historically used various metal halide lamps as their illumination source. Recently Philips Electronics NV introduced the 50 W UJoy Lamp and along with Seiko Epson, Nagano Japan, a reference design that utilizes a 0.47 inch TFT LCD microdisplay to enable less expensive “personal” projectors to be developed. These personal projectors are targeted at use with game consoles, digital cameras, PDA's, and video players.

Improvements in solid-state lasers and light emitting diodes (LED) has enabled the development of a new class of single/multi-viewer projectors small enough to put in a pocket and eventually incorporate directly into portable devices such as cell phones, PDA's and gaming devices. Example of these displays have been demonstrated publicly by Microdisplay Corporation, Redmond Wash., showing a “PicoP”, while Explay, Herzliya Israel has demonstrated a “Nano-Projector”, Kapellner et al., U.S. Patent Publication No. 2006/0279662. Both of these demonstrations are designed to fit into the hand and project images under about 30″. Some small projector designs utilize micro-display devices, while others directly project the scanned lasers form an image. In either case, there is a desire to project an image large enough for multiple people to see and portable enough to be conveniently transported. The anticipated portability of these projectors has created the need for technology, such as motion compensation for removing the vibration from a handheld device, to create stable projection. See e.g., U.S. Patent Application Publication No. 2003/0038927 by Alden. This has been demonstrated by Gruger et al., of the Fraunhofer IPMS, Dresden Germany where inertial sensors are utilized to sense motion, while the 2D micro-mechanical scanner system is driven to provide a stabilized image for the viewer.

In an office environment, there are typically white or light colored walls to enable the projected image from these portable projectors to be reasonably viewed. In the best of circumstances, a screen or white board is used with a rough surface to allow viewing without color skew, angular glare or other artifacts that might degrade the image quality presented to the viewer. This preferred viewing screen, however, is not available in many of the places that these new projectors may be used. Bedrooms may have walls painted colors other than a shade of white. Viewers in cars, buses, or outside may not have a flat relatively smooth surface to project upon. Therefore, there is a need for providing a convenient, quality projection surface that is portable enough for these new personal or pocket size projectors.

Portable devices, such as cell phones, PDA's, digital cameras, GPS navigation systems, and now projectors, are reasonably expensive and relatively delicate instruments that are highly valued by consumers. Owners and manufacturers of these devices often purchase or provide cases to protect these devices, as well as making them easily accessible. FIG. 1 shows a prior art example of a form fitting case 30 that serves this protective function for an electronic device 2. Additional methods include hard plastic holsters with mounting clips for the device and to attach the device to clothing as described in Motorola Inc, Schaumburg Ill., U.S. Pat. No. 6,176,401 by Wei Seong Lim and shown in FIG. 2. U.S. Pat. No. 6,781,824 by Krieger et al. assigned to Palm Inc, Sunnyvale Calif., describes a multi-direction hinged cover that provides both protection and a stand for the device. In this case the device is designed to remain in the case under use conditions. Other cases are fabricated as leather/vinyl pouches, silicon rubber sleeves, plastic and metal boxes with foam inserts.

Thus, there is a need for a solution that provides protection, mounting, connectivity, and improved viewing conditions for portable projectors.

### SUMMARY

Various embodiments of the present invention address one or more of the needs for providing storage, protective housing, and a projection surface for portable projection devices. In this regard, an embodiment of the present invention provides a case for holding a portable projection device, the case including a housing having interior surfaces for holding the portable projection device; and a projection screen for viewing images from the portable projection device.

It is a feature of some embodiments of the present invention that they provide ways for an apparatus to combine the functions of holding a portable projection device and containing a projection screen.

These and other objects, features, and advantages of embodiments of the present invention will become apparent to those skilled in the art upon a reading of the following detailed description when taken in conjunction with the drawings wherein there is shown and described illustrative embodiments of the invention.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a schematic drawing of prior art consisting of a portable electronic device and a rigid or semi-hard form fitting case;

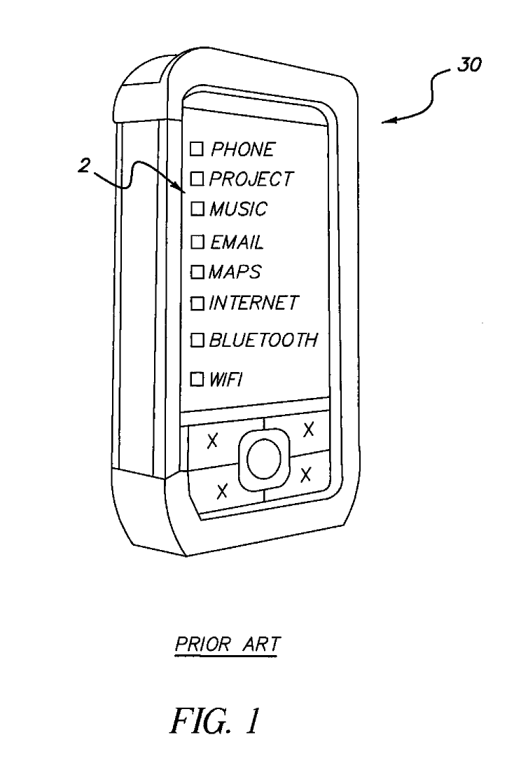

FIG. 2 is a schematic drawing of prior art consisting of a hard case intended to protect and house a portable electronic device;

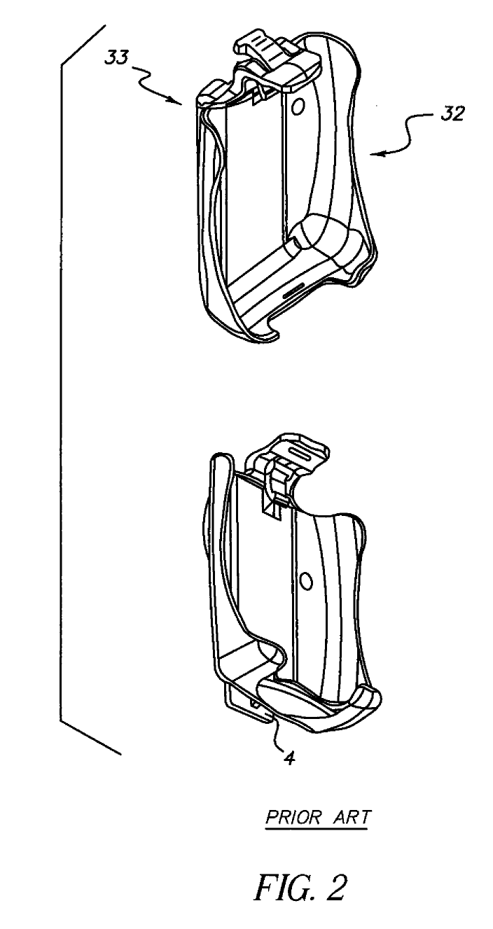

FIG. 3 illustrates an embodiment of the invention containing a form fitting case with a sample electronic device that contains a projection system where the case cover unfolds with a rigid projection screen;

FIG. 4 is a representation of a rigid projection screen separated from a case that is designed to house an electronic device containing a projection system, according to an embodiment of the present invention;

FIG. 5 is a representation of the rear of a projection screen structure with additional features designed to assist in holding the projection screen, according to an embodiment of the present invention;

FIG. 6 depicts an embodiment of a case holding an electronic device containing a projection system and a flexible screen that rolls up into a tube associated with the case;

FIG. 7 illustrates an embodiment of a case with a projection screen in a clamshell form factor;

FIG. 8 illustrates a clamshell embodiment showing additional attachment and mounting features as well as communication electronics and speakers;

FIG. 9 illustrates a clamshell embodiment incorporating a flexible screen with corner reinforcements that folds into the case and is supported by members that are part of the case;

FIG. 10 illustrates an embodiment of a rigid folding screen incorporated into a rigid case;

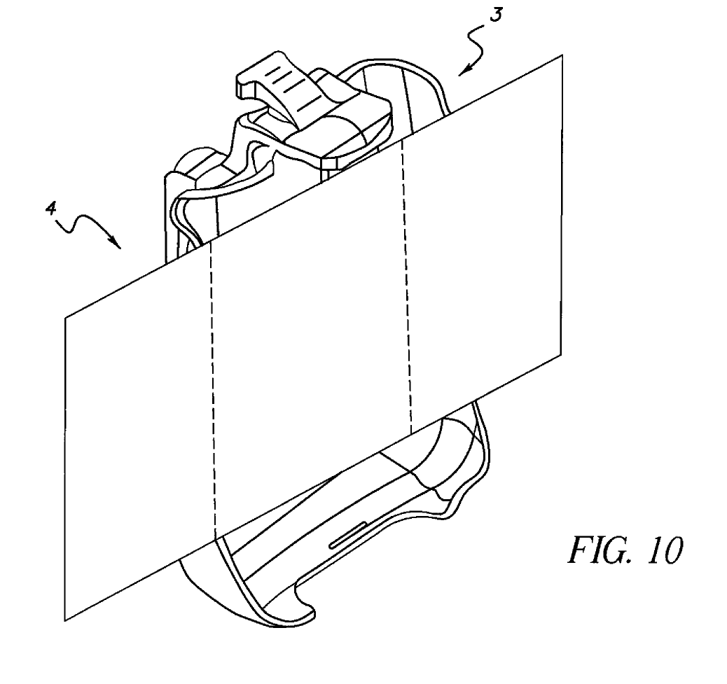

FIG. 11 illustrates an embodiment where a case with a portable projection device therein remains connected to a screen assembly when projecting an image; and

FIG. 12 illustrates an embodiment where a case with a portable projection device therein is separated from a screen assembly when projecting an image.

It is to be understood that the attached drawings are for purposes of illustrating the concepts of the invention and may not be to scale.

### DETAILED DESCRIPTION

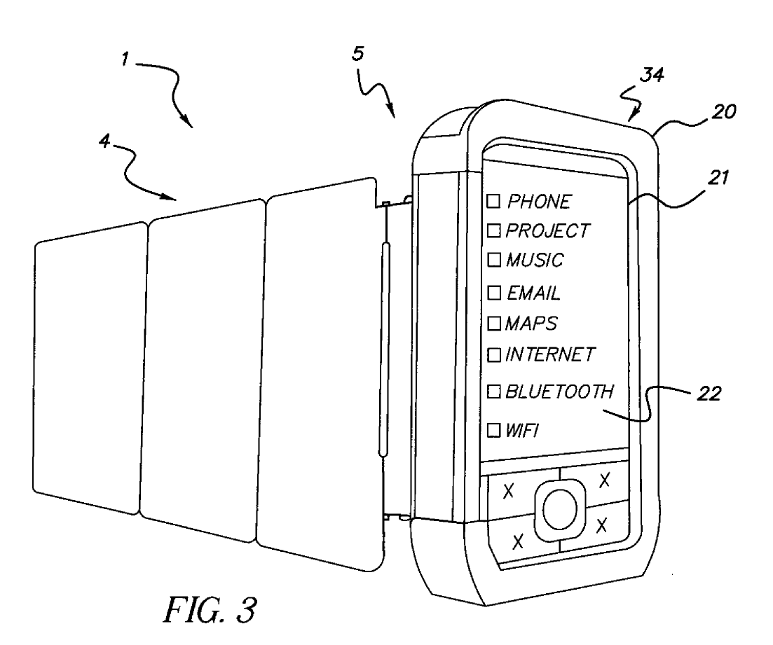

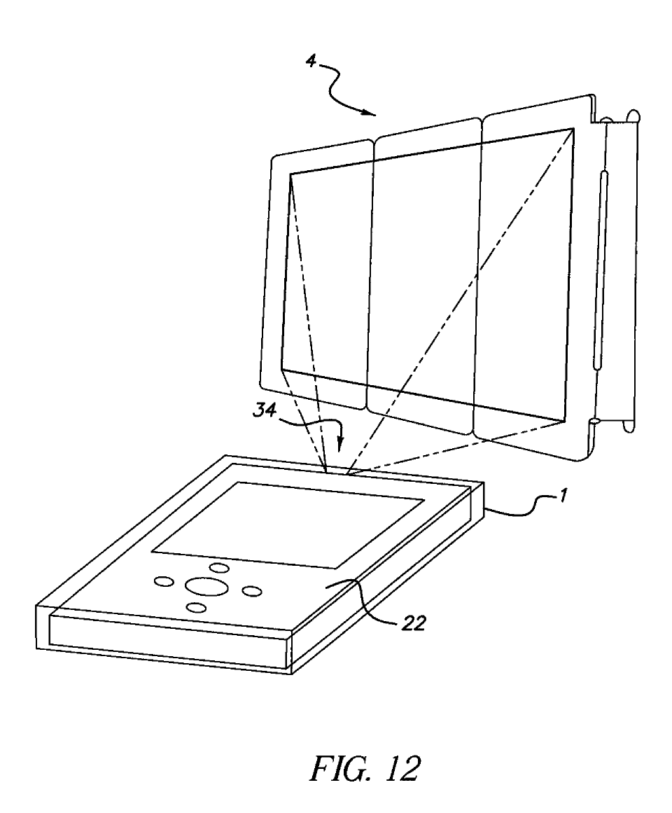

Portable projection devices, pocket projectors, and in the future, cell phones with projectors are or will be typically provided with or accessorized with a protective case. An object of embodiments of this invention is to add at least one additional purpose to such a case that is to house and/or be a part of a suitable projection surface. In one embodiment, shown in FIG. 3, a case 1 includes a housing 20 having interior surfaces 21 configured to hold a portable projection device 22, is designed to hold a separate projection screen assembly 4. In this example, the projection screen assembly 4 is part of a case cover and unfolds. A portable projection device 22 may be any device that includes a projector for projecting images. Examples of a portable projection device 22 include portable digital assistants (PDAs) or cell phones that include projectors. Note that such projectors are not shown in all figures because the invention is not limited to particular locations of projectors on portable projection devices. With that said, however, in the example of FIG. 3 a projector 34 may be located at a top portion of the portable projection device 22, as shown in more detail in FIG. 12.

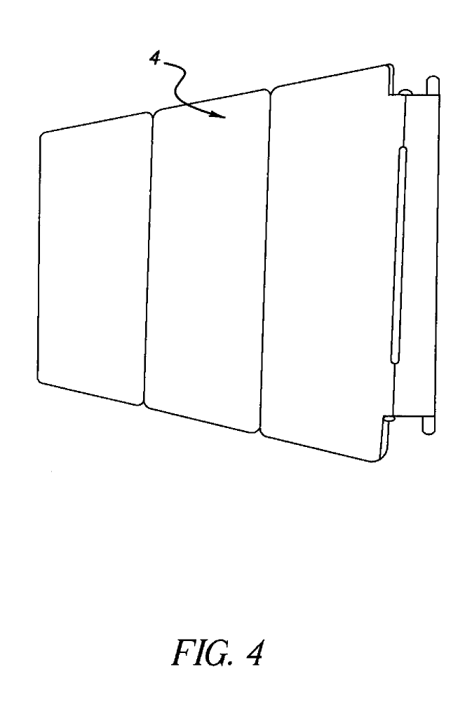

Returning to FIGS. 3 and 4, projection screen assembly 4 may separate from case 1 at the hinge section 5, as shown in FIG. 4. The semi-rigid projection screen assembly 4 unfolds as a case cover from three sections. This embodiment and similar embodiments, where a portion of the screen is incorporated as part of the case, provide an advantage of reduced overall case weight; an important consideration for portable devices. The cases 1 could be fabricated from traditional case materials including but not limited to semi-rigid plastics like polycarbonate or acrylic; metals like steel, stainless steel, aluminum or magnesium; soft materials like fabrics, such as lycra, polyester; natural materials like cotton, leather; or synthetic materials like silicon or silicon rubber.

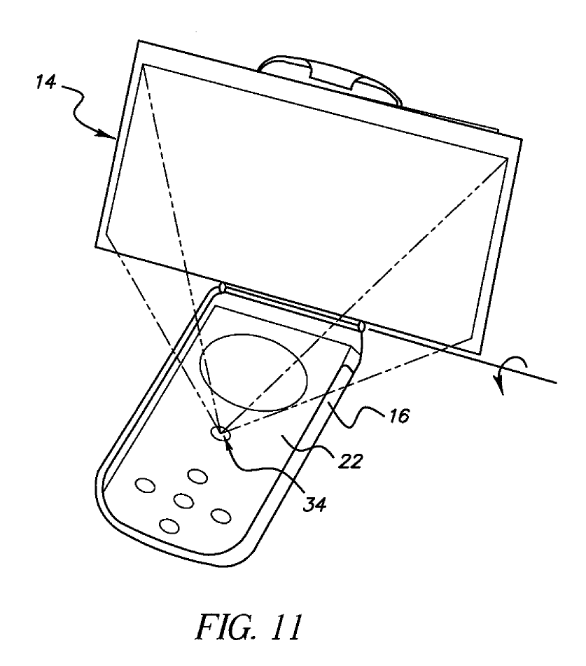

In the embodiment of FIGS. 3 and 4 and similar embodiments, in order to view images, case 1 with device 22 may be separated from or kept with the screen assembly 4. For example, as shown in FIG. 12, the screen assembly 4 may be separated from the case 1 and placed on a table, while a user spaces the case 1 with the portable projection device 22 away from the screen assembly 4 to properly project an image onto the screen assembly 4. Alternatively, as shown in FIG. 11, the portable projection device 22 and case 16 could remain together with the screen assembly 14 to project images directly onto the screen assembly 14. In this instance, the optics, electronics, or both, of the projection device 22 would preferably correct for keystone distortion, known in the art, from projecting to the screen assembly 14 at a non-normal incidence.

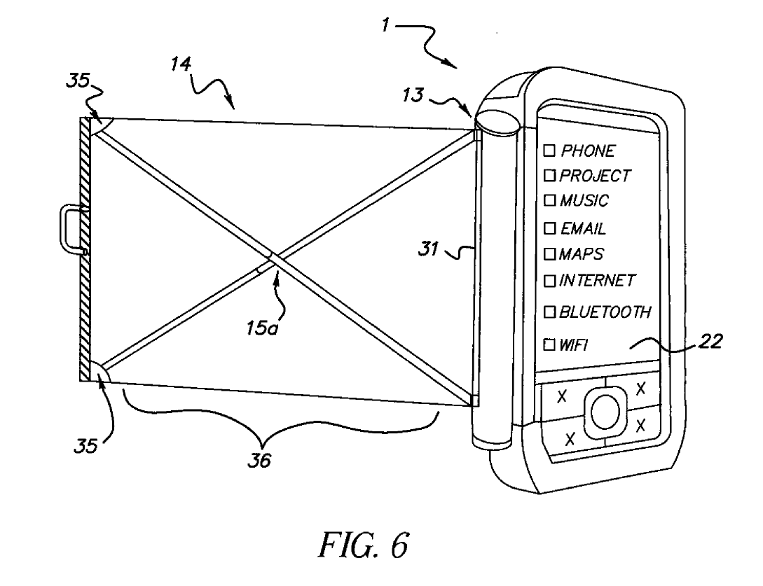

In an embodiment, depicted in FIG. 6, a flexible projection screen 14 may contain a white reflective, structured flexible material that unrolls from a portion of the case 1, such as tube container 13. The screen 14 may be made approximately flat by using support members 15a, which may be stored along the long-axis 31 of the tube container 13 or within the case 1 as a conventional stylus is stored.

The user may extend the support members 15a in a telescoping manner to fit into corner pockets 35 of the unrolled screen 14. In addition, the screen 14, along with tube container 13, may or may not be removable from the case 1. In this regard, the portable projection device 22 could again project directly from the case, preferably if keystone correction is provided, or be removed from the case 1 and directed toward the screen 14 for viewing. In the case where the screen 14 is detached from the case 1, the user may hand hold the projection device 22 to direct it toward the detached screen 14. An alternate embodiment would be to have the tube container 13 and unrolled screen 14 free-standing. For example, the projection screen 14 may unroll from the tube container 13 like a spring loaded window shade. In this case, support members 15a would be attached to tube container 13, pointed toward corner pockets 35, and extended thereto to make screen 14 a rigid projection surface. An additional leg (not shown) may extend from tube 13 or be attached to a bottom region 36 of the screen 14 to facilitate freestanding of the projection screen 14.

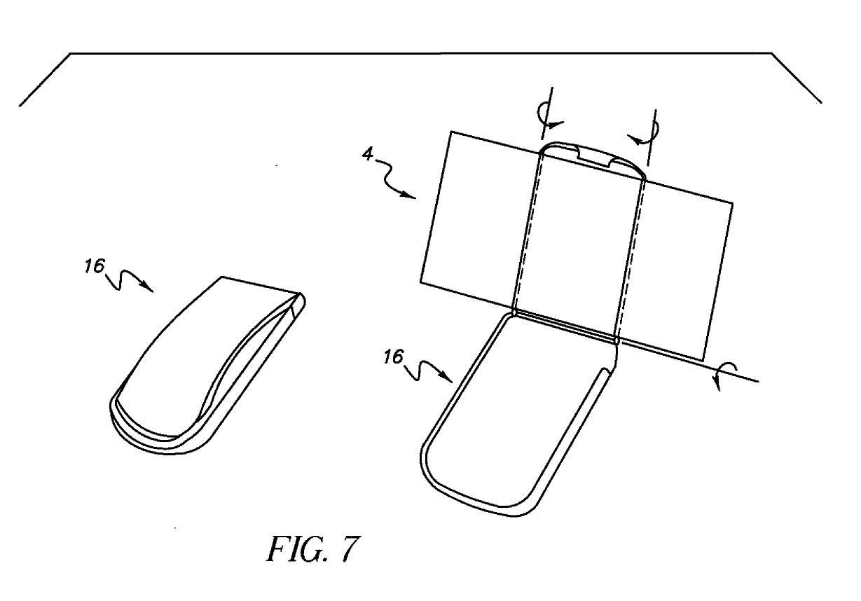

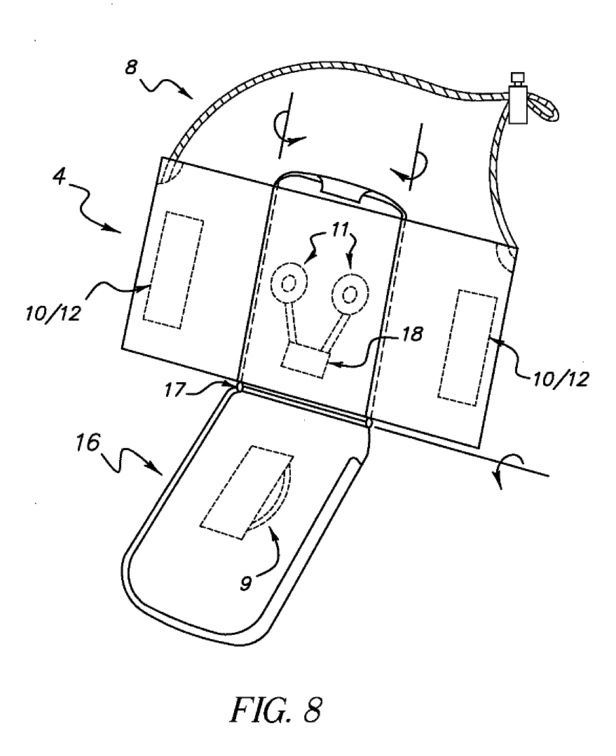

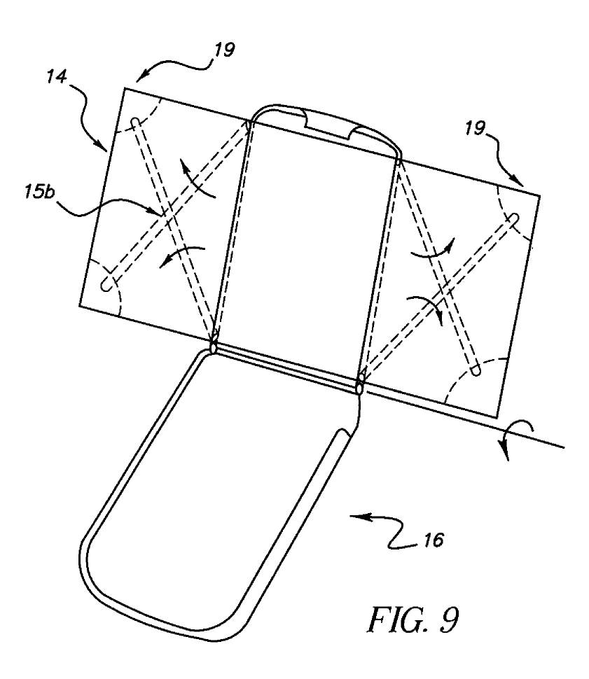

FIGS. 7-9 and 11 show a clamshell type case 16 where the top portion of the case contains a device cover that incorporates screen surfaces 4 or 14. The bottom portion of the clamshell case 16 may hold the portable projection device 22, as shown in FIG. 11. The top portion folds open via hinge 17 shown in FIG. 8. The embodiments of FIGS. 7-9 show the internal fabric of a clamshell case 16 which includes a screen material 14. In the embodiment of FIG. 9 when the case 16 is opened, the screen 14 is pulled tight using structural members 15b. The screen 14 may be pulled flat either automatically by the act of opening the screen 14 or manually by the user placing the support structures appropriately. As shown, the screen 14 may contain additional support pockets 19 to contain structural members 15b that fold and are contained in case 16. A user may remove the portable projection device 22 from case 16 and separately hold or position the portable projection device aimed with the radiation incident on the screen 14.

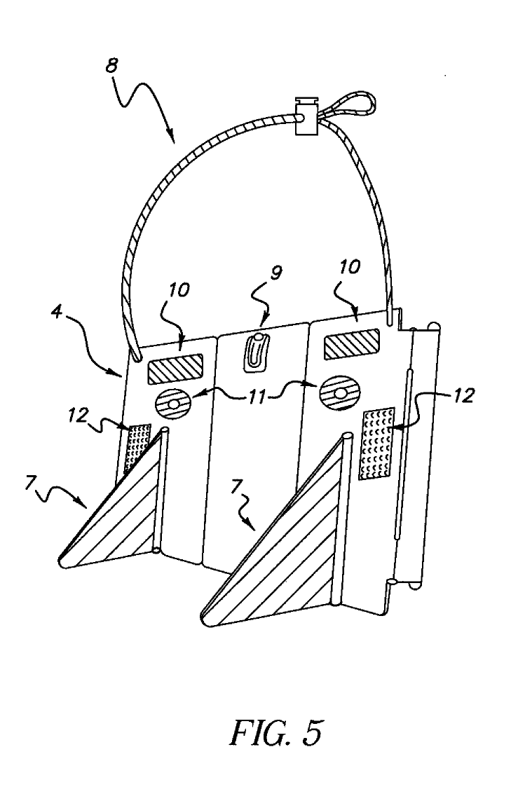

The screen material of screen 14 may be optimized for this type of projection, where projectors have projected-light limitations and, therefore, ambient light easily swamps out the projected image. To address this issue, the screen material may be a fabric, plastic or metal surface coated, laminated, or fabricated from materials that preferentially reflect the wavelengths of the projector, while absorbing the remaining ambient light. Sony Corp, Tokyo Japan and Dia Nippon Printing, Tokyo, Japan both have developed projection screen materials of this type. For laser diode based projectors, the light sources have very narrow spectrums, enabling substantial ambient light rejection. Similarly, laser diode based projectors may have speckle image artifacts due to the coherence of the light sources. The screens may have micro structured texture to minimize the appearance of speckle. Alternatively, the screens may have a means of vibrating the tight material such that the coherence is essentially broken. In the embodiments of FIGS. 5 and 8, this vibration comes from at least one speaker structure 11 similarly built into the case. Speaker structure 11 would be preferably significantly flat to allow easy packaging into the case as per the embodiment of FIGS. 3 and 4.

While the screen surfaces for these devices will typically reflect visible light from the projection device, other possibilities exist. For example, the projection device may emit non-visible radiation. In such a case, the screen may be tuned to absorb, reflect, or re-emit either the visible or non-visible radiation. One example of this would be for the projection device to emit common infrared radiation. The screen therefore may be designed to react to radiation, by means of phosphors, organic or inorganic layers, visible light corresponding to the images directed from the projector.

3D applications can be supported by this screen material structure by allowing either a variation in wavelength or polarization state to be reflected back to the viewer. In these cases the viewer(s) may wear either preferentially transmitting dichroic glasses, where each eye sees a slightly different spectral distribution that the projector would either sequentially or simultaneously emit. Alternatively, the projectors can sequentially or simultaneously display left and right images by different polarization states such as left and right-handed circular or two linear orthogonal states. In this case the viewer(s) would wear appropriate polarization transmitting filters on each eye to select the appropriate state. The screen material would therefore need to substantially preserve the polarization state of the incident light.

Additional features of the above-discussed embodiments are a means for holding the unfolded case with screen vertical or horizontal for viewing. This means would vary depending on the environment, therefore it is preferred that the case contain several methods of attachment. FIGS. 5 (shown from the rear of the projection surface) and 8 show examples of these methods; a mechanical clip 9, Velcro 12, magnetic strip 10, suction cups (not shown), hanging strap 8, and stand 7 could attach separately to the case or be built into the case. With either method, the case is prepared to hold and store the attachment mechanisms. While it may be desirable to incorporate all of the features in a single case, it may be difficult to store all such features if incorporated. Therefore, the user or manufacturer may decide to install only some portion of the mounting features. For example, hanging strap 8 or stand 7 might be too large to fold into the case completely. Therefore, they may be provided to the user as add on features, while magnetic strips and Velcro lay flat and would easily fold to a compact package. Clip 9 may or may not lie flat, but also may be small enough to allow it to be folded along with the screen substrate inside the case to contain it or likewise may folded to be on the outside of the case. These attachment methods would enable the screen to be fastened to or set onto many surfaces, for example, metal walls, white boards and refrigerators, fabric partitions, car headrests, windows, painted walls, clothing, drapery, belts and straps.

The case/screen may also contain an electronic means 18 of communication to the projector for calibration, synchronizing, audio signal or sharing other information as depicted in FIG. 8. This could be RFID or other means of wireless transmission. Alternatively, a wired connection, (not shown) could be used to transfer information, such as audio signals or calibration data.

The invention has been described in detail with particular reference to certain preferred embodiments thereof, but it will be understood that variations and modifications can be effected within the spirit and scope of the invention.

Thus, what is provided is an apparatus and method for holding a portable projection device and a projection screen as part of the case for viewing images.

### PARTS LIST

1 Semi-rigid form fitting electronic device case
2 Portable electronic device
3 Rigid electronic device case
4 Projection Screen Assembly
5 Separable hinge mechanism
7 Fold out stand
8 Hanging strap
9 Mechanical clip
10 Magnetic mounting strips
11 Speakers
12 Hook and loop fasteners
13 Tube container for containing rolled up flexible projection screen
14 Projection screen assembly
15a Telescoping flexible screen support members
15b Flexible screen support members
16 Clamshell case
17 Hinge for rotating projection screen and/or cover
18 Communication electronics from between the projector to the screen
19 Screen reinforcement to hold flexible screen support members
20 Housing
21 Housing Interior
22 Portable projection device
30 Conventional Case
31 Long Axis
32 Rigid Case
33 Clip
34 Projector
35 Corner Pocket
36 Bottom Region

1. A case for holding a portable projection device, the case comprising:
a housing having interior surfaces for holding the portable projection device; and
a projection screen for viewing images from the portable projection device.

2. A case as claimed in claim 1, further comprising a fastener configured to fasten the projection screen to a body external to the case.

3. A case as claimed in claim 2, wherein the fastener is a mechanical clip, a hook and loop fastener, a magnetic strip, a hanging strap, or a lanyard strap.

4. A case as claimed in claim 1, further comprising a stand configured to stand the case on a horizontal or substantially horizontal surface.

5. A case as claimed in claim 1, wherein the projection screen comprises a surface configured at least to complement radiation projected from the portable projection device.

6. A case as claimed in claim 5, wherein the surface complements the radiation at least by reducing visual speckle, preferentially reflecting a spectrum associated with the radiation compared to ambient illumination, or maintaining a polarization state of the radiation.

7. A case as claimed in claim 1, further comprising a vibration mechanism configured to vibrate the projection screen.

8. A case as claimed in claim 1, further comprising a communication system configured at least to receive audio information from the portable projection device; and a speaker configured to project audio based at least upon the audio information.

9. A case as claimed in claim 8, wherein the communication system is configured at least to receive the audio information wirelessly.

10. A case for holding a portable projection device, the case comprising:
a housing having interior surfaces configured at least to hold the portable projection device; and
a housing configured at least to store a projection screen.

11. A case as claimed in claim 10, further comprising a fastener configured to fasten the projection screen to the case.

12. A case as claimed in claim 11, wherein the fastener is a mechanical clip, a hook and loop fastener, a magnetic strip, a hanging strap, or a lanyard strap.

13. A case as claimed in claim 10, further comprising a stand configured to stand the case on a horizontal or substantially horizontal surface.

14. A case as claimed in claim 10, further comprising a vibration mechanism configured to vibrate the projection screen.

15. A case as claimed in claim 10, further comprising a communication system configured at least to receive audio information from the portable projection device; and a speaker configured to project audio based at least upon the audio information.

16. A case as claimed in claim 15, wherein the communication system is configured at least to receive the audio information wirelessly.

17. A case for holding a portable projection device, the case comprising:
a housing having interior surfaces configured at least to hold the portable projection device;
a projection screen configured at least to reflect or transmit images from said portable projection device;
a data processing system; and
a communication system configured at least to share information between said portable projection device and the data processing system.

18. The case as claimed in claim 17, wherein the communication system is configured at least to share the information wirelessly.
